(19) United States
(12) Patent Application Publication
(10) Pub. No.: US 2012/0033099 A1
(43) Pub. Date: Feb. 9, 2012

(54) PHOTO-DETECTOR AND METHOD FOR DETECTING AN OPTICAL RADIATION

(75) Inventors: Federico Zaraga, Milano (IT); Giacomo Langfelder, Milan (IT)

(73) Assignee: POLITECNICO DI MILANO, Milan (IT)

(21) Appl. No.: 13/260,288

(22) PCT Filed: Mar. 25, 2010
(86) PCT No.: PCT/EP2010/053922

§ 371 Date: Sep. 24, 2011

(30) Foreign Application Priority Data
Mar. 30, 2009 (IT) MI2009A000500

(51) Int. Cl. H04N 9/73

(52) U.S. Cl. 348/223.1; 348/E09.052

(57) ABSTRACT

An image acquisition system comprises a radiation photodetector implementing at least two tunable spectral responses indicating the photodetector sensitivity as a function of the wavelength. The photodetector includes means for receiving at least two configuration signals controlling the tuning of at least part of the shape of the at least two spectral responses. The system comprises a control module for receiving an identification signal indicating the spectral intensity of a source of light, detecting that the source spectral intensity shape in at least one spectrum portion is different from the reference spectral intensity shape in the at least one spectrum portion, and changing a configuration signal in order to change a spectral response shape in the at least one spectrum portion as a function of the difference between the shape of the source spectral intensity and the shape of the reference spectral intensity in the at least one spectrum portion.

### BACKGROUND

1. Technical Field

The present disclosure generally relates to the field of the photo-detectors for digital cameras. More particularly, the present disclosure concerns a photo-detector and a method for performing the white balancing and concerns a camera and a video-camera comprising said photo-detector.

2. Description of the Related Art

It is known that the color of an image of an object acquired with a digital camera can change depending on the type of the source of light illuminating the object. For example, the image of a white object taken with sunlight can be different from the image of the same white object taken with the light of a fluorescent lamp.

Therefore it is necessary to compensate the differences among light sources, so that the white of an image does not depend on the light source: this operation is commonly indicated with “white balance”.

The white balance is generally performed using simple multiplicative factors, independently, using the von Kries law, or using a digital processing of the acquired image, for example performing a linear correction of each color or performing an analog amplification of the electrical signals measured by the portions of the photo-detector responsive to the colors used as primary colors.

Other techniques for performing the white balance are known: see, for example, the patent documents US 2006/0098108 in the name of Pentax, US 2005/0001912 in the name of Nikon Corporation, U.S. Pat. No. 6,995,791 in the name of Freescale Semiconductor Inc., US 2006/0262198 in the name of Sony Corporation.

U.S. Pat. No. 5,612,738 discloses (see FIG. 3) a system for compensating for color deviation in an image produced by an image capturing and reproducing apparatus such as a camera. The system includes a liquid crystal section (see 77) which is an external filter tunable according to one voltage signal (see the line connecting the control circuit 76 to the liquid crystal section 77). Therefore there is only one filter.

US patent application having publication nb. 2007/0076093 discloses a variable sensitivity imaging device including photo-electric converting layers (such as organic layers) stacked above a semiconductor substrate, wherein the sensitivity can be adjusted according to a voltage applied to the photo-sensitive layer. More specifically, FIG. 7 shows that only the amplitude of the spectral sensitivity can be adjusted, while the shape can't be changed (thus the spectral sensitivity is not tunable).

US patent application having publication nb. 2007/0015301 discloses a light sensor in which the spectral sensitivity can be adjusted by adjusting the absorption depth of a depletion region according to the bias voltage between a poly gate and a substrate (see in FIG. 2A the depletion region 23, the poly gate 28 and the substrate 30). Moreover, it suggests (see par. 26) that the same image can be taken with a different spectral sensitivity (as a function of different bias voltages) at different times over a different spectrum (for example, infra-red and visible regions).

The Applicant has observed that the known techniques for the acquisition of the images have at least one of the following disadvantages:
they are not very efficient, for example they are not capable of satisfactorily performing the white balance;
they are too complex, for example they can perform the white balance, but they require a photo-detector which is too complex and thus too expensive;
they deteriorate the signal/noise ratio and deteriorate the quality of the acquired image;
they require an additional processing of the acquired signal, thus deteriorating the resolution and/or the contrast.

### BRIEF SUMMARY

One embodiment of the present disclosure relates to a system for acquisition of an image. The system includes a photo-detector of a radiation, the photo-detector being configured for implementing at least two tunable spectral responses indicating the sensitivity of the photo-detector as a function of the wavelength, the photo-detector including means for receiving at least two configuration signals controlling the tuning of at least part of the shape of the at least two spectral responses respectively. The system further includes a control module configured for receiving an identification signal indicating the spectral intensity of a source of light and detecting that the shape of the source spectral intensity in at least one spectrum portion is different from the shape of a reference spectral intensity in the at least one spectrum portion, and configured for changing a configuration signal out of the at least two configuration signals in order to change the shape of a spectral response out of the at least two spectral responses in the at least one spectrum portion as a function of the difference between the shape of said source spectral intensity and the shape of said reference spectral intensity in the at least one spectrum portion.

In accordance with another aspect of the present disclosure, the control module is further configured for changing another configuration signal out of the at least two configuration signals in order to change the shape of another spectral response out of the at least two spectral responses in the at least one spectrum portion as a function of the difference between the shape of said source spectral intensity and the shape of said reference spectral intensity (CIE D65) in the at least one spectrum portion.

In accordance with another aspect of the present disclosure, the photo-detector is configured to implement at least three tunable spectral responses and the means are adapted to receive at least three configuration signals controlling the tuning of at least part of the shape of the at least three spectral responses respectively as a function of the difference between the shape of said source spectral intensity and the shape of said reference spectral intensity in at least three spectrum portions, and wherein the photo-detector is further adapted to generate at least three electrical signals as a function of the at least three configuration signals respectively, wherein the control module is further adapted to change the at least three configuration signals so that the at least three generated electrical signals are substantially equal each other when the photo-detector is adapted to detect a radiation scattered by a white object.

In accordance with another aspect of the present disclosure, the at least two tunable spectral responses are implemented with at least two tunable spectral responsivities.

In accordance with another aspect of the present disclosure, the photo-detector includes a substantially depleted semiconductor region adapted to generate carriers at at least three depths as a function of the wavelength of the detected optical radiation, wherein the means include at least three electrodes arranged in the semiconductor region, wherein the at least three configuration signals are the voltage of the at least three electrodes and the at least three generated electrical signals are at least three current signals, wherein the at least three electrodes are adapted to collect the carriers generated at the at least three depths and are adapted to generate therefrom the at least three current signals respectively, wherein the control module is adapted to change the voltage of a first electrode out of the at least three electrodes in order to change the intensity of the current generated at the first electrode and to decrease the difference between the current generated at the first electrode and the current generated at a second electrode out of the at least three electrodes.

In accordance with another aspect of the present disclosure, the control module is further adapted to change the voltage of the first electrode for increasing the intensity of the current generated at the first electrode and is adapted to change the voltage of the second electrode for decreasing the intensity of the current generated at the second electrode, so that the intensity of the current generated at the first electrode is substantially equal to the intensity of the current generated at the second electrode when the photo-detector is adapted to detect a radiation scattered by a white object.

In accordance with another aspect of the present disclosure, the photo-detector including a semiconductor region including at least three depleted regions at different depths adapted to generate carriers as a function of at least three wavelengths of the detected optical radiation, wherein the at least three generated electrical signals are at least three current signals including the carriers generated at the least three depleted regions respectively.

In accordance with another aspect of the present disclosure, the at least two tunable spectral responses are three tunable spectral responses being function of the wavelengths substantially corresponding to red, green, blue visible radiation respectively and wherein three spectrum portions include the wavelengths substantially corresponding to red, green, blue visible radiation.

One embodiment of the present disclosure is a method for detecting a radiation. The method comprises the step of receiving information indicating the spectral intensity of a source of light, comprises the step of providing a photo-detector implementing at least two spectral responses indicating the sensitivity of the photo-detector as a function of the wavelength, wherein at least part of the shape of the at least two spectral responses is tunable, comprises the step of providing at least two configuration signals for controlling the tuning of the at least part of the shape of the at least two spectral responses, comprises the step of detecting that the shape of the source spectral intensity in at least one spectrum portion is different from the shape of a reference spectral intensity in the at least one spectrum portion, and comprises the step of changing a configuration signal out of the at least two configuration signals in order to change the shape of a spectral response out of the at least two spectral responses in the at least one spectrum portion as a function of the difference between the shape of said source spectral intensity and the shape of said reference spectral intensity in the at least one spectrum portion.

In accordance with another aspect of the embodiment, the step of detecting includes the detection that the values of the source spectral intensity in a spectrum portion are smaller than the values of the reference spectral intensity in said spectrum portion and the step of changing includes the change of said configuration signal in order to increase the values of said spectral response in said spectrum portion.

In accordance with another aspect of the embodiment, the step of changing includes changing another configuration signal out of the at least two configuration signals in order to change the shape of the other spectral response in the at least one spectrum portion as a function of the difference between the shape of said source spectral intensity and the shape of said reference spectral intensity (CIE D65) in the at least one spectrum portion.

In accordance with another aspect of the embodiment, the step of changing includes changing at least three configuration signals in order to change the shape of at least three spectral responses respectively in at least three spectrum portions as a function of the difference between the shape of said source spectral intensity and the shape of said reference spectral intensity in the at least three spectrum portions, in order to perform a white balancing of the radiation scattered by a white object and detected by the photo-detector.

In accordance with another aspect of the embodiment, the at least two spectral responses are tunable by changing at least two spectral responsivities of the photo-detector.

In accordance with another aspect of the embodiment, the at least two spectral responses are three tunable spectral responses being function of the wavelengths substantially corresponding to red, green, blue visible radiation respectively and wherein three spectrum portions include the wavelengths substantially corresponding to red, green, blue visible radiation.

The Applicant is aware of the fact that the photo-detector and the method according to the present disclosure can perform the acquisition of an image in an efficient, simple and cheap way. Moreover, it has the advantage of avoiding to deteriorate the signal/noise ratio, to keep a good quality of the acquired image and not to require additional processing of the acquired signal.

Another embodiment of the present disclosure is a digital camera including the image acquisition system described above.

Another embodiment of the present disclosure is a digital video-camera including the image acquisition system described above.

Another embodiment of the present disclosure is a computer readable medium having a program recorded thereon, said computer readable medium comprising computer program code means adapted to perform the steps of detecting and changing of the method described above, when said program is run on a computer.

### BRIEF DESCRIPTION OF THE SEVERAL VIEWS OF THE DRAWINGS

Other characteristics and advantages of the disclosure will be understood from the following description of a preferred embodiment and its variations provided as an example with reference to the attached drawings, wherein:

FIG. 1 schematically shows a system for acquisition of an image according to an embodiment of the disclosure,

FIG. 2 schematically shows the pattern of the spectral intensity of a source of light of CIE A type and of the reference spectral intensity of CIE D65 type,

FIG. 3 schematically shows the variation of the pattern of the spectral responsivities of a photo-detector according to an embodiment of the disclosure,

FIGS. 4 and 5 schematically show a transversal field photo-detector according to an embodiment of the disclosure.

### DETAILED DESCRIPTION

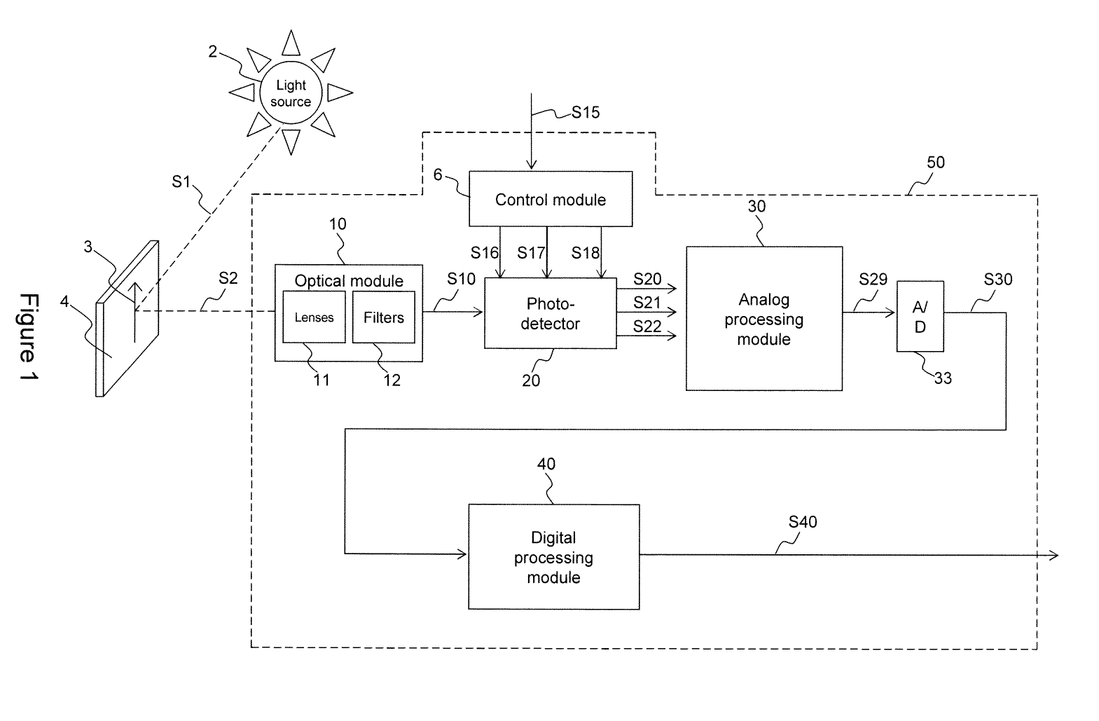

With reference to FIG. 1, it is shown a system 50 for the acquisition of an image according to an embodiment of the disclosure. The acquisition system 50 is for example a part of a digital camera or of a digital video-camera.

FIG. 1 schematically further shows a light source and an object 3 having a diffusive surface 4. The light source 2 is configured to emit an optical radiation S1 towards the object 3 (the optical radiation S1 is schematically shown by a single optical ray, however it comprises a beam of optical rays) and the surface 4 is configured to diffuse an optical radiation S2 of the object 3 towards the acquisition system 50 (also the diffused optical radiation S2 is schematically shown as a single optical ray, however it comprises a beam of optical rays).

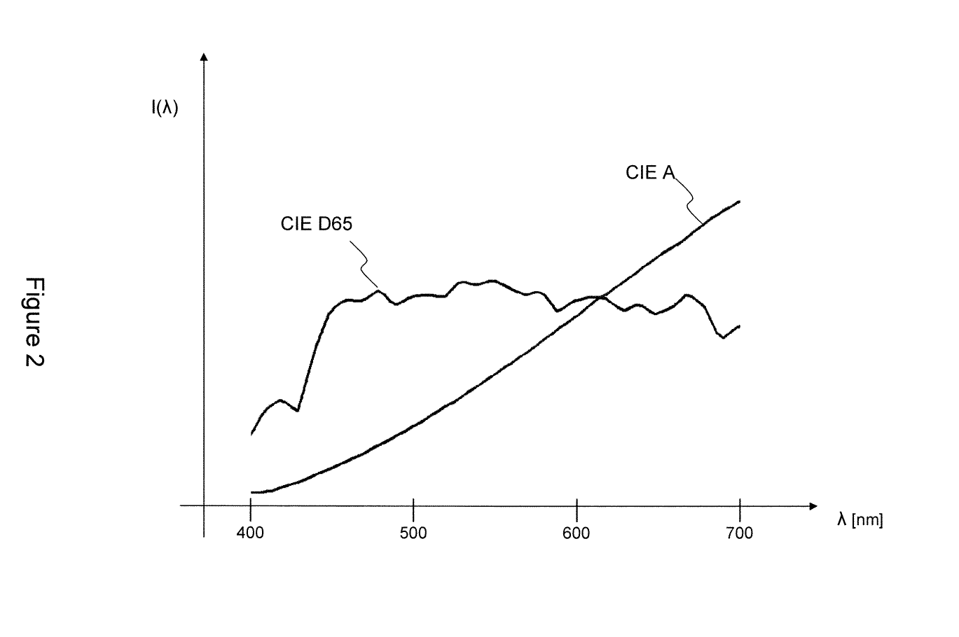

The light source 2 is for example the sunlight or the light emitted by an incandescent lamp. FIG. 2 schematically shows the pattern of the spectral intensity of CIE D65 type and the spectral intensity of a light source of CIE A type. The spectral intensity of CIE D65 type is the daylight with a color temperature of about 6500° Kelvin and the light source of CIE A type is the artificial light of an incandescent lamp with a color temperature of about 2800° Kelvin. It is to be noted that the light source of CIE A type has a spectral intensity with a relative intensity towards the red greater than the relative intensity of the spectrum towards the red of the spectral intensity of CIE D65 type; viceversa, the relative intensity towards the green and blue of the spectral intensity of CIE D65 type is greater than the relative intensity of the spectrum towards the green and blue of the light source of CIE A type. Therefore the shape of the spectral intensity of CIE D65 type is very different from the shape of the spectral intensity of the light source of CIE A type.

The acquisition system 50 is configured to acquire a digital image of the object 3. Specifically, the acquisition system 50 comprises:
a control module 6;
an optical module 10;
a photo-detector 20;
an analog processing module 30;
an analog-to-digital converter 33;
a digital processing module 40.

The control module 6 is configured to receive an identification signal S15 indicating the spectrum (indicated in the following by S(λ)) of the light source 2. For example, the identification signal S15 indicates the spectrum (for example, the spectral intensity) of the sunlight in a clear or cloudy day (in case of an outdoor photo) or indicates the spectrum of a light emitted by an incandescent lamp (in case of a photo inside a building).

The spectrum of the light source 2 is commonly represented by the color temperature of a black body which emits a radiation with said spectrum: according to this assumption, the identification signal S15 is represented by a number in Kelvin degrees. For example, the color temperature in case of an incandescent light of 200 W is about 2900° Kelvin, in case of the sunlight with a cloudy sky is about 6500° Kelvin.

In the following, it is supposed that the spectrum of the light source 2 is known and thus that the identification signal S15 is known. For example:
the spectrum of the light source 2 is known before the acquisition of the image of the object 3. In case of a camera, this can be obtained by means of the user who sets on the camera the type of light source 2; in this case, the system 50 of FIG. 1 further comprises an identification module of the source (not shown in FIG. 1) having the function of identifying the spectrum of the light source 2 and configured to generate the identification signal S15;
the light source 2 spectrum is calculated from the acquired image of the object 3 by means of suitable software algorithms. In this case, the calculating operation is performed in the system 50 of FIG. 1 by a module (not shown in FIG. 1) inside the digital processing module 40 in order to generate the identification signal S15;
the light source 2 spectrum is measured by the light incident from the light source 2 by means of an auxiliary photo-detector. In this case, the system 50 of FIG. 1 further comprises said auxiliary photo-detector (not shown in FIG. 1) in order to generate the identification signal 15.

The control module 6 is configured to provide three configuration signals S16, S17, S18 to the photo-detector 20 (for example, three configuration electrical signals, as it will be described more in detail in the following) for tuning the three spectral responsivities respectively of the photo-detector 20 as a function of the identification signal S15, as it will be described more in detail in the following. More generally, the number of configuration signals is greater than one, because the number of the spectral responsivities of sensor 20 is greater than one.

FIG. 1 shows that the control module 6 is divided from the photo-detector 20, but the control module 6 can also be placed inside the photo-detector 20.

Preferably, the acquisition system 50 further comprises a memory (not shown in FIG. 1) connected to the control module 6 for storing a plurality of temperature values of the light source 2 and corresponding values (at least one) of the configuration signals S16, S17, S18.

The optical module 10 is configured to receive the optical radiation S2 diffused by the object 3 and to transmit a focalized optical radiation S10 obtained as a function of the optical radiation S2. For example, the optical module 10 comprises one or more lenses 11 for focusing the diffused optical radiation S2 in a focal point in order to maximize the focalized optical radiation S10 intensity and comprises one or more filters 12 for filtering the infrared wavelengths and for performing a low-pass filtration for avoiding alias.

The photo-detector 20 is configured to receive the focalized optical radiation S10, is configured to receive from the control module 6 the three configuration signals S16, S17, S18 and is configured to convert the focalized optical radiation S10 received in three electrical signals S20, S21, S22 (e. g., three currents or voltages), as it will be more particularly explained in the following. Therefore the three electrical signals S20, S21, S22 depend on the intensity and spectrum of the focalized optical radiation S10 received from the photo-detector 20 and depend on the configuration signals S16, 17, 18 calculated from the spectrum of the light source 2.

More generally, the acquisition system 50 is configured to acquire a whole image and thus is configured to generate a digital image comprising a plurality of pixels (e. g., four millions of pixels). Therefore, more generally, the photo-detector 20 is configured to receive the radiation S10, is configured to receive at least one configuration signal S16 (or S17, or S18) and is configured to generate at least one electrical signal (similar to signal S20 or S21 or S22) for each pixel of the acquired image, wherein the at least one electrical signal generated by the photo-detector for the different pixels can be different from each other. Moreover, it is to be noted that the number of the configuration signals generated by the control module 6 (and received by the photo-detector 20) can depend on the number of light sources: in the example of FIG. 1, in case it is present another light source, the photo-detector 20 is configured to receive other three configuration signals.

For simplicity it is considered in the following (for the purpose of explaining the disclosure) a photo-detector 20 configured to acquire a digital image with one pixel, but similar considerations can be done for a photo-detector 20 configured to acquire a digital image with a plurality of pixels.

Moreover, it is to be noted that the number of electrical signals S20, S21, S22 can be (for each pixel) greater than three (advantageously, it is equal to four).

More specifically, the electrical signals S20, S21, S22 are for example calculated by the following formulas:

S20=∫(λₘᵢₙ, λₘₐₓ)S(λ)*r(λ)*T(λ)*R₁(λ) dλ

S21=∫(λₘᵢₙ, λₘₐₓ)S(λ)*r(λ)*T(λ)*R₂(λ) dλ

S22=∫(λₘᵢₙ, λₘₐₓ)S(λ)*r(λ)*T(λ)*R₃(λ) dλ

wherein:
S(λ) is the spectrum of the light source 2;
r(λ) is the reflectance of the surface 4 of the object 3;
T(λ) is the transmittance of the optical module 10;
R₁(λ), R₂(λ), R₃(λ) are the spectral responsivities of photo-detector 20, which are defined as the intensity of currents (or voltages) generated by the photo-detector 20 divided by the power of the radiation incident on the photo-detector 20, as a function of the variation of the wavelength λ of the incident radiation (in this case, the incident radiation is the received radiation S10).

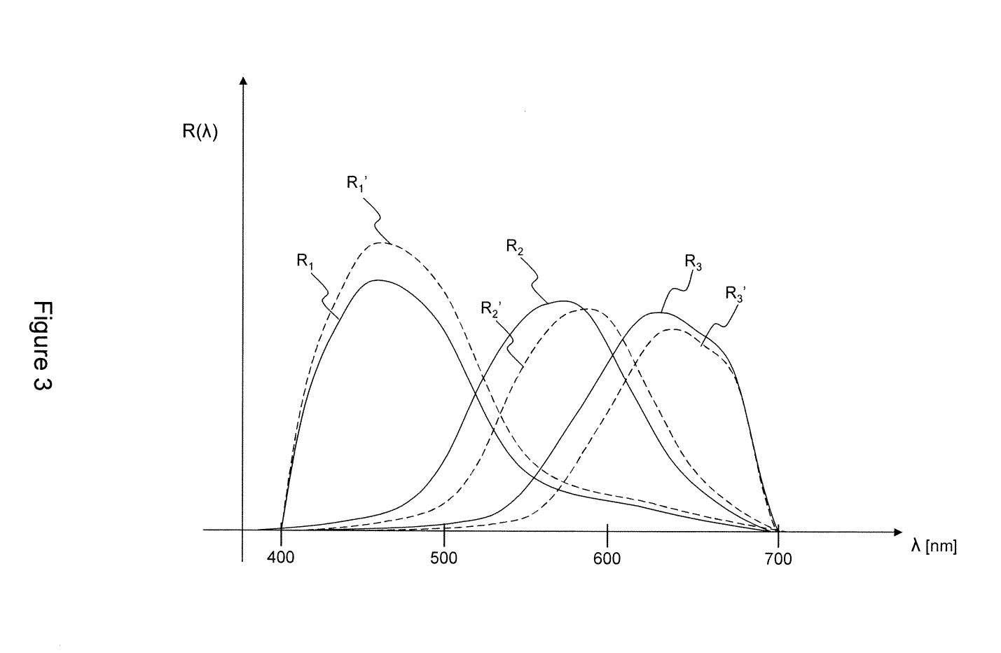

Typically, λₘᵢₙ=380 and λₘₐₓ=780 nm in case of a radiation in the visible spectrum and the spectral responsivities R₁(λ), R₂(λ), R₃(λ) have, for example, a pattern having a maximum value in the bands of the shortest wavelengths (for example, blue), intermediate (for example green) and longest (for example, red) respectively, as shown in FIG. 3 with R₁, R₂, R₃ and as it will be explained more in detail in the following.

More generally, the photo-detector 20 is configured to implement at least one spectral response, which is defined as the sensitivity of the photo-detector 20 during the generation of electric charges as a function of the variation of the wavelength λ of the radiation incident on the photo-detector 20. The at least one spectral responsivity R₁(λ), (or R₂(λ) or R₃(λ)) of the photo-detector 20 previously indicated is a specific example of the at least one spectral response of the photo-detector 20 (another example is the quantum efficiency of the photo-detector 20).

The photo-detector 20 is configured to implement at least one spectral responsivity R₁(λ), (or R₂(λ), or R₃(λ)) depending on the spectrum, as shown in FIG. 3 by the solid line R₁ (or R₂ or R₃). Moreover, the at least one spectral responsivity R₁(λ), (or R₂(λ) or R₃(λ))—and more generally, the at least one spectral response—of the photo-detector 20 is tunable as a function of at least one configuration signal S16 (or S17 or S18) respectively, that is it is possible to modify the shape of at least one spectral responsivity R₁(λ), (or R₂(λ), or R₃(λ)) in the visible spectrum, as shown in FIG. 3 by the broken line R₁′ (or R₂′ or R₃′): the configuration signal S16 is configured to modify the shape of the spectral responsivity from R₁ to R₁′ as a function of the difference between the shape of the light source 2 spectral intensity and the shape of a reference spectral intensity, as it will be more specifically explained in the following. Similarly, the configuration signal S17 is configured to modify the shape of the spectral responsivity from R₂ to R₂′ as a function of the difference between the shape of the light source 2 spectral intensity and the shape of a reference spectral intensity, as it will be more particularly explained in the following, and the configuration signal S18 is configured to modify the shape of the spectral responsivity from R₃ to R₃′ as a function of the difference between the shape of the light source 2 spectral intensity and the shape of a reference spectral intensity, as it will be explained more in detail in the following.

In the previous example of three spectral responsivities, the spectral responsivities R₁(λ), R₂(λ), R₃(λ) of the photo-detector 20 are tunable as a function of the configuration signals S16, S17, S18 respectively calculated by the spectrum S(λ) of the light source 2, as it will be explained more in detail in the following with reference to the description of FIGS. 2 and 3; consequently, the three electrical signals S20, S21, S22 are calculated as a function of the three tunable spectral responsivities R₁(λ), R₂(λ), R₃(λ).

For the purpose of explaining the disclosure, in the following it is considered a photo-detector 20 configured to implement three spectral responses tunable as a function of the three configuration signals S16, S17, S18 and the three electrical signals S20, S21, S22 are calculated as a function of the three tunable spectral responses R₁(λ), R₂(λ), R₃(λ) of the photo-detector 20.

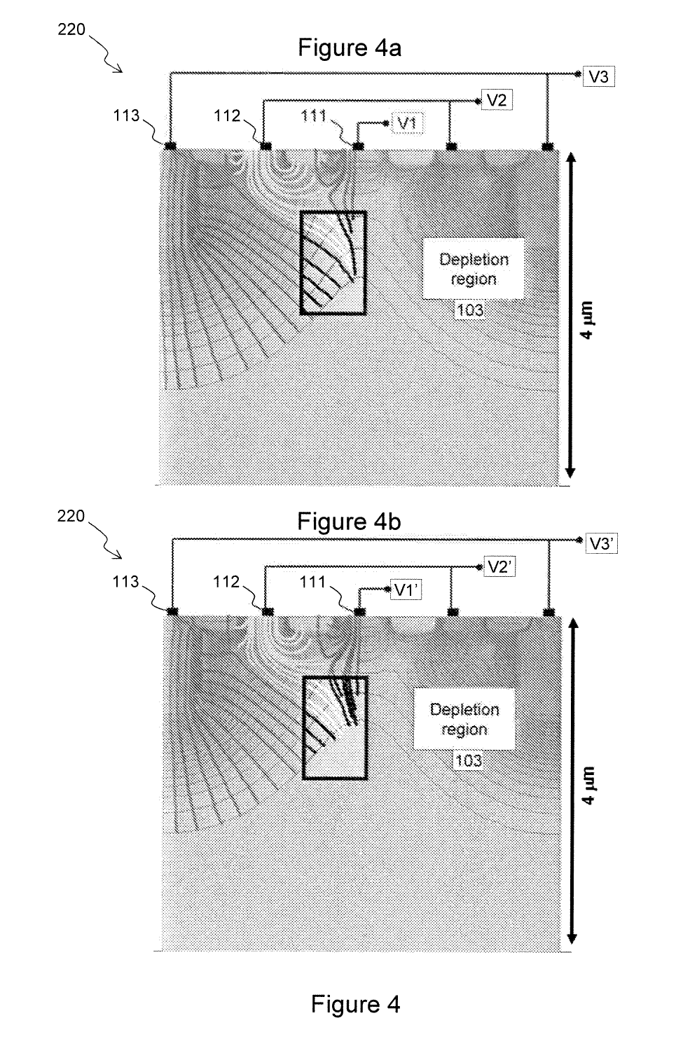

The three spectral responses of the photo-detector can be tuned by changing the three spectral responsivities R₁(λ), R₂(λ), R₃(λ) of the photo-detector 20, as it will be explained more in detail with reference to the description of FIGS. 3 and 4.

The three spectral responses of the photo-detector can also be tuned using three tunable filters configured to receive the focalized optical radiation S10 and configured to generate three filtered optical radiations S11, S12, S13 (not shown in FIG. 1) obtained from the focalized optical radiation S10 by means of the three tunable filters. The three tunable filters are, for example, made of dichroic liquid crystals (see the United States Patent Application having publication number US 2007/0046794) by which it is possible to change the optical transmittance, that is it is possible to change the spectral intensity of the transmitted radiation with respect to the received radiation.

The tunable filters can be placed inside the photo-detector 20, that is the spectral responses of the photo-detector 20 are tuned by changing the optical transmittances of the tunable filters.

The tunable filters can also be placed in the optical module 10: in this case the optical module 10 is configured to receive the three configuration signals S16, S17, S18 and is configured to provide to the photo-detector 20 three filtered optical radiations obtained from the optical radiation S2 (and subsequent processing performed in the optical module 10) by means of the three tunable filters.

The analog processing module 30 is configured to receive the three electrical signals S20, S21, S22 (more generally, three electrical signals for each pixel) and it is configured to generate an analog signal S29 (generally, an analog signal for each pixel) as a function of the three electrical signals S20, S21, S22. For example, the analog processing module 30 comprises the series connection of a module for reading the three electrical signals S20, S21, S22, of three analog amplifiers and, preferably, of a module for the white analog balance.

The analog-to-digital converter 33 is configured to receive the analog signal S29 and is configured to provide the digital signal S30 (more generally, a digital signal for each pixel) obtained by means of the sampling of the received analog signal S29 and quantizing the sampled signal.

The digital processing module 40 is configured to receive the digital signal S30 and is configured to provide a processed digital signal S40 obtained from the digital signal S30 by means of one or more functions of digital signal processing. For example, the digital processing module 40 comprises a module for demosaicing, a module for digital white balance, a module for color correction, a module for noise reduction, a module for transforming a color into a standard color space and a module for digital compression.

Moreover, it is to be noted that the spectral intensity of CIE D65 type shown in FIG. 2 is commonly taken as a reference for evaluating the capacity of color acquisition of digital cameras; therefore the values of the electrical signals S20, S21, S22 are substantially equal when the acquisition system 50 is configured to receive a radiation S10 of a white object illuminated by a light source 2 with a spectral intensity of CIE D65 type. Alternatively, the values of three electrical signal of system 50 subsequent to the electrical signals S20, S21, S22 are substantially equal each other, as for example the values of three electrical signals at the output of three analog amplifiers of the analog processing module 30.

It will be described the operation of the acquisition system 50 of FIG. 1, with reference also to FIGS. 2 and 3. The photo-detector 20 has three tunable spectral responsivities R₁, R₂, R₃ having an initial shape shown in FIG. 3: the initial shape of the three spectral responsivities R₁, R₂, R₃ has been tuned as a function of a reference spectral intensity of CIE D65 type shown in FIG. 2.

It is supposed that a light source 2 has a spectral intensity having a pattern, as a function of the wavelength, of CIE A type shown in FIG. 2.

Moreover, it is supposed that the values (at least one) of the configuration signals S16, S17, S18 corresponding to the light source 2 of CIE A type have been pre-calculated and that said values have been stored in the system 50 (for example, in a memory) and that they can be read from the control module 6.

The light source 2 emits the optical radiation S1 towards the object 3 and the surface 4 diffuses the optical radiation S2 of the object 3 towards the acquisition system 50.

The optical module 10 receives the optical radiation S2, performs a processing of the optical radiation S2 and transmits the processed radiation as radiation S10.

The control module 6 receives the identification signal S15 indicating the spectrum of the light source 2 of CIE A type, reads the pre-calculated values corresponding to the light source of CIE A type and provides the configuration signals S16, S17, S18 having said read values.

The values of the configuration signals S16, S17, S18 change the spectral responsivities R₁, R₂, R₃ of the photo-detector 20, so that the new spectral responsivities of the photo-detector 20 are R₁′, R₂′, R₃′ shown in FIG. 3. Specifically, it is to be noted the following behaviour:
the spectral intensity of the light source 2 of CIE A type in the spectrum portion comprised between about 400 nm and about 500 nm is much smaller than the reference spectral intensity of CIE D65 type. In this case, the spectral responsivity in this spectrum portion is increased, as it can be observed by the shape of R₁′ with respect to R₁;
the spectral intensity of the light source 2 of CIE A type in the spectrum portion comprised between about 500 nm and about 600 nm is smaller than the reference spectral intensity of CIE D65 type. In this case, the spectral responsivity in this spectrum portion is partially reduced and partially increased as it is shown by the shape of R₂′ with respect to R₂;
the spectral intensity of the light source 2 of CIE A type in the spectrum portion comprised between about 600 nm and about 700 nm is substantially greater than the reference spectral intensity of CIE D65 type. In this case, the spectral responsivity in the spectrum portion is reduced as it is shown by the shape of R₃′ with respect to R₃.

Therefore the photo-detector 20 allows to compensate the differences between the spectral intensity of light source 2 of CIE A type and the reference spectral intensity of CIE D65 type, by means of the tunability of the spectral responsivities R₁, R₂, R₃ of the photo-detector 20.

The photo-detector 20 receives the optical radiation S10 and converts it into three electrical signals S20, S21, S22.

The analog processing module 30 receives the three electrical signals S20, S21, S22 and generates the analog signal S29.

The analog-to-digital converter 33 receives the analog signal S29 and provides the digital signal S30.

The digital processing module 40 receives the digital signal S30 and provides the processed digital signal S40.

Preferably, the control module 6 comprises a processor for calculating three values for tuning the three spectral responsivities of the photo-detector 20, respectively; alternatively, the processor is configured to read from a memory three pre-calculated values for tuning the three spectral responsivities of the photo-detector 20 respectively. The control module further comprises an electronic circuit for converting the three calculated or pre-calculated values into the three configuration signals S16, S17, S18; alternatively, the electronic circuit can be implemented into the photo-detector 20.

Advantageously, the 0 spectral responsivities R₁(λ), R₂(λ), R₃(λ) of the photo-detector 2 are tunable in order to perform a white balance of the acquired image of the object 3.

In this case, the photo-detector 20 is configured to receive the configuration signals S16, S17, S18 for tuning the spectral responses (by means of the variation of the spectral responsivities R₁(λ), R₂(λ), R₃(λ) of the photo-detector 20 or by means of tunable filters) in order to have the electrical signals S20, S21, S22 with substantially equal values when the acquisition system 50 is configured to receive an optical radiation S10 of a white object 3.

With reference to FIG. 2, it is to be noted that the difference between the shape of the spectral intensity of the CIE D65 type and of the CIE A type is the cause of a not much effective white balance in the solutions according to the prior art, while the solution according to the disclosure has the advantage of performing in this case an effective white balance.

Preferably, it is possible to find (for a determined light source 2) different shapes of the spectral responsivities R₁(λ), R₂(λ), R₃(λ) which allow to perform the white balance and therefore it is possible that the control module 6 calculates or pre-calculates (for a determined light source 2) two or more values of the configuration signals S16, S17, S18 which allow to perform the white balance.

The configuration signals S16, S17, S18 values which allow to perform the white balance can be calculated in different ways.

A first way for obtaining the white balance is to pre-calculate the values (at least one) of the configuration signals S16, S17, S18 for the different light sources 2. Therefore the values (at least one) of the configuration signals S16, S17, S18 which are configured to generate values of the electrical signals S20, S21, S22 substantially equal each other are calculated, in the conditions wherein the optical module is configured to receive the diffused radiation S2 from a white object illuminated by a light source 2 with a defined spectrum (different from the spectrum of the CIE D65 type). This operation is repeated for different possible light sources 2, thus obtaining the values (at least one) of the configuration signals S16, S17, S18 for the different light sources 2 which allow to perform the white balance.

A second way for obtaining the white balance is to calculate the values (at least one) of the configuration signals S16, S17, S18 for the light source illuminating the scene by means of a pre-acquisition of the image. Subsequently, the dots (that is, the pixels) in the pre-acquired image are identified and for these dots the values (at least one) of the configuration signals S16, S17, S18 are calculated, which are configured to generate values of the electrical signals S20, S21, S22 substantially equal. The system 50 acquires again the image and the photo-detector 20 is configured (by means of the previous step) in order to have the spectral responsivities tuned for the white balance.

A third way for obtaining the white balance is to use a white object and calculating the values (at least one) of the configuration signals S16, S17, S18 for the light source 2 illuminating the scene by means of a pre-acquisition by the system 50 of an image diffused from the white object. Therefore the values (at least one) of the configuration signals S16, S17, S18 which are configured to generate values of the electrical signals S20, S21, S22 substantially equal are calculated. Therefore the system 50 acquires the image of the object 3 and the photo-detector 20 is configured (by means of the previous step) in order to have the spectral responsivities tuned for the white balance.

The operation of the acquisition system 50 for the white balance is similar to what has been described above, with the difference that the values (calculated or pre-calculated) of the configuration signals S16, S17, S18 corresponding to the light source 2 having a spectral intensity of CIE A type are specific values (preferably, more than one) allowing to have values of the electrical signals S20, S21, S22 (or values of the three electrical signals of the system 50 subsequent to the electrical signals S20, S21, S22) substantially equal when the system 50 acquires the image of the white object 3 illuminated by a light source having a spectral intensity of CIE A type.

Advantageously, the − spectral responsivities R₁(λ), R₂(λ), R₃(λ) of the photo-detector 20 are tunable in order to perform an optimization of the color correction (in the digital processing module 40) of the acquired image of the object 3.

Advantageously, the spectral responsivities R₁(λ), R₂(λ), R₃(λ) of the photo-detector 20 are tunable in order to perform both a white balance of the acquired image of the object 3 and a reduction of the error in the operation of color correction of the acquired image of the object 3. In fact, it is possible to find different possible shapes of the spectral responsivities R₁(λ), R₂(λ), R₃(λ) (for a defined light source 2) that allows to perform the white balance (so it is possible to find two or more values of the configuration signals S16, S17, S18). Consequently, it is possible to choose one of the possible shapes of the spectral responsivities R₁(λ), R₂(λ), R₃(λ) (that is, it is possible to choose one between two or more configuration signals S16, S17, S18 values) allowing not only to perform the white balance, but also to reduce the error in the color correction.

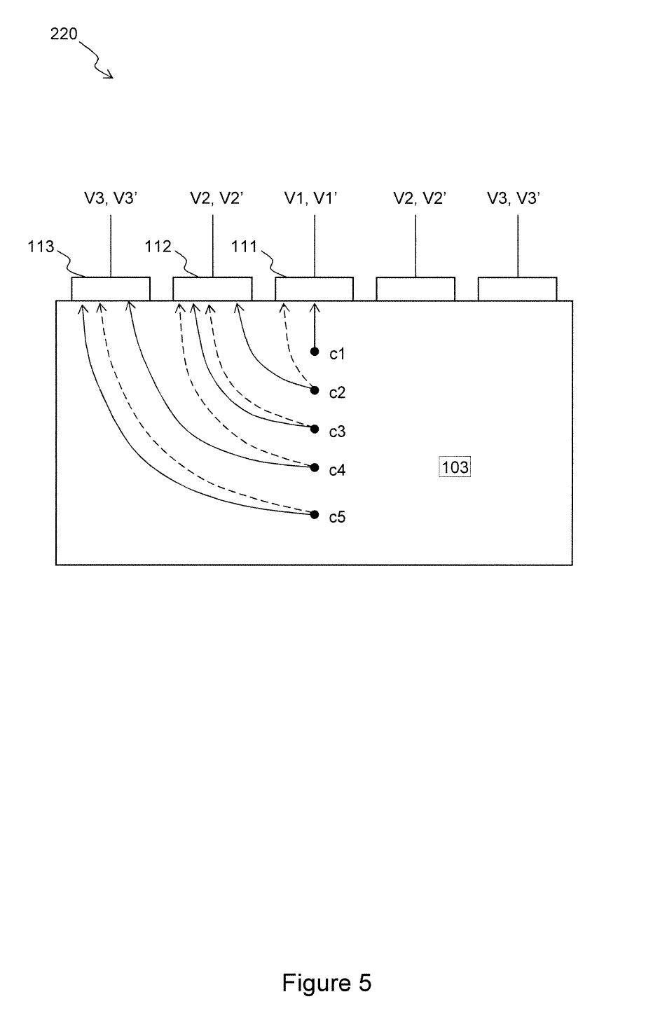

With reference to FIGS. 4 and 5, a transversal field photo-detector 220 is schematically shown, which allows to implement a photo-detector 20 having three spectral responsivities tunable as a function of the three configuration signals S16, S17, S18 calculated from the spectrum of the light source 2. The transversal field photo-detector 220 has been described in detail in the Italian Patent Application No. MI2006A002352 filed on Dec. 6, 2006 and in the international Patent Application No. PCT/IB2007/003906 filed on Dec. 5, 2007, both of the same inventors; in the following it will be recalled the main elements of the photo-detector 220.

The transversal field photo-detector 220 employs the principle that in a semiconductor material the semiconductor absorption coefficient depends on the wavelength of the incident radiation. The transversal field photo-detector 220 comprises a semiconductor material layer having a depletion region 103 and comprises three electrodes 111, 112, 113 for generating electric fields in the depletion region 103 and for collecting electric charges generated at different depth due to an optical radiation incident on the photo-detector 220. The electric fields generated in the depletion region 103 are configured to generate trajectories different as a function of the depth of the charges generated in the depletion region 103, as shown in FIG. 4a and in FIG. 5 with solid lines.

The configuration signals S16, S17, S18 of FIG. 1 are three electrical signals respectively, specifically they are three voltages V1, V2, V3 of electrodes 111, 112, 113 of the transversal field photo-detector 220 and the electrical signals S20, S21, S22 are three currents (measured at electrodes 111, 112, 113) generated from the charges collected at the depletion region 103.

Therefore, the electrodes 111, 112, 113 of the transversal field photo-detector 220 are configured to implement three corresponding spectral responsivities, which can be tuned varying the voltages V1, V2, V3 applied to electrodes 111, 112, 113.

Specifically, FIGS. 4a and 4b schematically show the pattern of the electric field in the depletion region 103 (and the trajectories of the charges generated in the depletion region 103) which allows to obtain spectral responsivities similar to those shown in FIG. 3 with a solid and broken line respectively, applying suitable potential difference values between electrodes 111, 112, 113 and the semiconductor material layer with the depletion region 103.

Specifically:
FIG. 4A schematically shows the pattern of the equipotential lines of the electric fields generated in the depletion region 103 (and the trajectories of the charges generated in the depletion region 103) which allows to obtain spectral responsivities similar to those shown in FIG. 3 with a solid line, applying at potentials of electrodes 111, 112, 113 voltage values V1, V2, V3 respectively (for example, V1, V2, V3 are comprised between 1 and 3 Volt).
FIG. 4b schematically shows the pattern of the equipotential lines of the electric fields generated in the depletion region 103 (and the trajectories of the charges generated in the depletion region 103) which allows to obtain spectral responsivities similar to those shown in FIG. 3 with a broken line applying at potentials of electrodes 111, 112, 113 the voltage values V1′, V2′, V3′ respectively, wherein for example V1′ is greater than V1, V2′ is smaller than V2, V3′ is smaller than V3.

FIG. 3 schematically shows, more in detail, the trajectories of five electric charges c1, c2, c3, c4, c5 generated at different depths in the depletion region 103 and collected at the electrodes 111, 112, 113. The solid lines represent the trajectories of five electric charges c1, c2, c3, c4, c5 when at potentials of electrodes 111, 112, 113 are applied voltage values V1, V2, V3 respectively; the broken lines represent the trajectories of the five electric charges c1, c2, c3, c4, c5 when at potentials of electrodes 111, 112, 113 are applied the voltage values V1′, V2′, V3′ respectively. It is to be noted the following behaviour:
charge c1 is collected by electrode 111 both when the potential values at electrodes 111, 112, 113 are V1, V2, V3 respectively and when the potential values of electrodes 111, 112, 113 are V1′, V2′, V3′ respectively;
charge c2 is collected by electrode 111 when the potential values at electrodes 111, 112, 113 are V1, V2, V3 respectively, while is collected by electrode 112 when the potential values of electrodes 111, 112, 113 are V1′, V2′, V3′ respectively;
charge c3 is collected by electrode 112 both when the potential values of electrodes 111, 112, 113 are V1, V2, V3 respectively and when potential values of electrodes 111, 112, 113 are V1′, V2′, V3′ respectively;
charge c4 is collected by electrode 112 when the potential values of electrodes 111, 112, 113 are V1, V2, V3 respectively, while is collected by electrode 113 when the potential values of electrodes 111, 112, 113 are V1′, V2′, V3′ respectively;
charge c5 is collected by electrode 113 both when the potential values of electrodes 111, 112, 113 are V1, V2, V3 respectively and when potential values of electrodes 111, 112, 113 are V1′, V2′, V3′ respectively.

Advantageously, the transversal field photo-detector 220 can be used for performing the white balance of the acquired image of the object 3 (as previously explained with reference to the acquisition system 50 photo-detector 20), because the photo-detector 220 allows to tune the spectral responsivities generated by electrodes 111, 112, 113 by varying the potentials V1, V2, V3 of electrodes 111, 112, 113: this is achieved by means of the control module 6, which drives the photo-detector 220 electrodes 111, 112, 113, as a function of the identification signal S15 calculated by the spectrum of the light source 2 and sets suitable voltage values V1, V2, V3 to electrodes 111, 112, 113, so that the values of the currents S20, S21, S22 generated by the photo-detector 220 are substantially equal when the image of a white object is acquired.

It will be described the operation of the control module 6 of the acquisition system 50 wherein the photo-detector 20 is substituted by the transversal field photo-detector 220, supposing the white balancing. Moreover, it is supposed that the acquisition system 50 comprises a memory for storing a plurality of temperature values of the light source 2 and corresponding values (at least one) of the configuration voltages V1, V2, V3 which allow to perform the white balance.

The control module 6 receives the identification signal S15 indicating the specific temperature value of the light source 2 illuminating the object 3, reads from the memory three voltage values corresponding to the value of the particular color temperature and drives (by means of an electric circuit) the electrodes 111, 112, 113 setting to the configuration voltages V1, V2, V3 the values read from the memory which allow to have currents S20, S21, S22 substantially equal when the image of a white object is acquired. For example, if the current S20 detected at electrode 111 is smaller than the current S22 detected at electrode 113 and the current S21 detected at electrode 112 is comprised between the current S20 and S22, the control module 6 increases the voltage value V1 of the electrode 111 in order to increase the intensity of the current S20 generated from the electrode 111 and reduces the value of the voltage of the electrode 113 in order to decrease the intensity of the current S22 generated from the electrode 113, so that the current S20, S21, S22 intensities are approximately equal when the photo-detector 220 receives a radiation diffused from a white object.

Advantageously, the transversal field photo-detector 220 performs both the white balance of the acquired image of object 3 and decreases the error in the operation of color correction of the acquired image of the object 3, as previously explained with reference to the photo-detector 20 of the acquisition system 50. In this case, the system 50 comprises a memory storing a plurality of values of the temperature of the light source 2 and corresponding values (at least two) of the configuration voltages V1, V2, V3 and also stores the color correction matrixes corresponding to the values of the configuration voltages V1, V2, V3.

The transversal field photo-detector 220 has the advantage of not decreasing the quantum efficiency. In fact, by varying the potentials of the electrodes 111, 112, 113, it is possible to modify the directions of charges generated from a radiation incident on the photo-detector 220 and thus it is possible to change the electrode wherein a generated charge is collected: however, it doesn't change the number of charges collected as a whole at the electrodes 111, 112, 113, that is all the charges generated in the depletion region 103 are used for generating current from the photo-detector 220. For example, comparing FIG. 4a with respect to FIG. 4b, it is possible to observe a change of the trajectories of the charges collected by electrodes 113 and 112: in FIG. 4a some trajectories are directed towards the electrode 113, while in FIG. 4b the same trajectories are directed towards the electrode 112.
The transversal field photo-detector 220, when it is configured to tune the spectral responsivities for performing the white balance, has the advantage of decreasing (or also eliminating) the white balance operations performed at analog level in the analog processing module 40 (for example, the gain control of the analog amplifier is reduced or eliminated) or at a digital level in the digital processing module 40. For example, it is possible to perform an analog white balance by equalizing at least three analog electrical signals by means of at least three amplifiers in the analog processing module 30, amplifying the weakest electrical signal and attenuating the strongest electrical signal, in order to have substantially equal values of the electrical signals of the signals generated by the amplifiers. However, it is disadvantageous to amplify the weakest electrical signal, because this also causes a noise amplification; moreover, it is disadvantageous to attenuate the strongest electrical signal, because it decreases the quantum efficiency of the photo-detector (that is, some charges, which have been generated by the incident radiation, are lost). The white balance inside the photo-detector 220 allows to decrease (or eliminate) the operation of amplifying and attenuating the analog electrical signals in the amplifiers inside the analog processing module 30.

It is also possible to perform a digital white balance in the digital processing module 40, for example performing a independent linear correction of the primary colors (red, green, blue) using the von Kries law, so that the digital values of the primary colors have the same value when the image of a white object 3 is acquired. Also in this case, it is amplified not only the smallest digital value of one among the primary colors, but it is also increased the noise: the white balance in the photo-detector 220 allows to decrease (or eliminate) the white balance operation in the digital processing module 40.

It is to be noted that it is possible to implement a photo-detector 20 having tunable spectral responsivities by using also photo-detectors different from the transversal field photo-detector 220 of FIG. 4. For example, it is possible to use a photo-detector implemented with three (or more) stacked depletion regions at different depths, wherein each depletion region absorbs a different wavelength of the optical radiation incident on the photo-detector (see for example U.S. Pat. No. 5,965,875 in the name of Foveon). In this case, the tunable spectral responsivities are obtained by varying the depth extension of the depletion regions by means of suitable variations of the voltages applied at the depletion region junctions. Therefore the previous considerations regarding the tunable spectral responsivities for performing the white balance or the color correction can be also applied to the photo-detector implemented by three (or more) stacked depletion regions.

The method of the embodiment according to the disclosure can be implemented by means of a software program running on a microprocessor, which can be an independent microprocessor or can be a microprocessor inside a specific or programmable integrated circuit (for example, a FPGA=Field Programmable Gate Array).

The programming language used for the software program code can be for example C or VHDL (Very high-speed integrated circuit Hardware Description Language) or Verilog. Particularly, the software program performs the steps of:
detecting that the shape of the spectral intensity of the source 2 in at least one spectrum portion is different from the shape of a reference spectral intensity (for example, CIE D65) in the at least one spectrum portion;
tuning the shape of at least one spectral response (for example, R₁) in the at least one spectrum portion as a function of the difference between the shape of the spectral intensity of the source 2 and the shape of said reference spectral intensity in the at least one spectrum portion.

The various embodiments described above can be combined to provide further embodiments. All of the U.S. patents, U.S. patent application publications, U.S. patent application, foreign patents, foreign patent application and non-patent publications referred to in this specification are incorporated herein by reference, in their entirety. Aspects of the embodiments can be modified, if necessary to employ concepts of the various patents, application and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1.-17. (canceled)

18. System for acquisition of an image, the system including:
a photo-detector of a radiation, the photo-detector being configured to implement at least two tunable spectral responses indicating the sensitivity of the photo-detector as a function of the wavelength, the photo-detector including means for receiving at least two configuration signals controlling the tuning of at least part of the shape of the at least two spectral responses respectively;
a control module configured to:
receive an identification signal indicating the spectral intensity of a source of light and detecting that the shape of the source spectral intensity in at least one spectrum portion is different from the shape of a reference spectral intensity in the at least one spectrum portion;
change a configuration signal out of the at least two configuration signals in order to change the shape of a spectral response out of the at least two spectral responses in the at least one spectrum portion as a function of the difference between the shape of said source spectral intensity and the shape of said reference spectral intensity in the at least one spectrum portion.

19. System according to claim 18, wherein the photo-detector is configured to implement at least three tunable spectral responses and the means are adapted to receive at least three configuration signals controlling the tuning of at least part of the shape of the at least three spectral responses respectively as a function of the difference between the shape of said source spectral intensity and the shape of said reference spectral intensity in at least three spectrum portions, and wherein the photo-detector is further adapted to generate at least three electrical signals as a function of the at least three configuration signals respectively, wherein the control module is further adapted to change the at least three configuration signals so that the at least three generated electrical signals are substantially equal each other when the photo-detector is adapted to detect a radiation scattered by a white object.

20. System according to claim 19, the photo-detector including:
a substantially depleted semiconductor region adapted to generate carriers at at least three depths as a function of the wavelength of the detected optical radiation;
wherein the means include at least three electrodes arranged in the semiconductor region;
wherein the at least three configuration signals are the voltage of the at least three electrodes and the at least three generated electrical signals are at least three current signals;
wherein the at least three electrodes are adapted to collect the carriers generated at the at least three depths and are adapted to generate therefrom the at least three current signals respectively,
wherein the control module is adapted to change the voltage of a first electrode out of the at least three electrodes in order to change the intensity of the current generated at the first electrode and to decrease the difference between the current generated at the first electrode and the current generated at a second electrode out of the at least three electrodes.

21. System according to claim 20, wherein the control module is further adapted to change the voltage of the first electrode for increasing the intensity of the current generated at the first electrode and is adapted to change the voltage of the second electrode for decreasing the intensity of the current generated at the second electrode, so that the intensity of the current generated at the first electrode is substantially equal to the intensity of the current generated at the second electrode when the photo-detector is adapted to detect a radiation scattered by a white object.

22. System according to claim 19, the photo-detector including a semiconductor region including at least three depleted regions at different depths adapted to generate carriers as a function of at least three wavelengths of the detected optical radiation,
wherein the at least three generated electrical signals are at least three current signals including the carriers generated at the least three depleted regions respectively.

23. System according to claim 18, wherein the control module is further configured to change another configuration signal out of the at least two configuration signals in order to change the shape of another spectral response out of the at least two spectral responses in the at least one spectrum portion as a function of the difference between the shape of said source spectral intensity and the shape of said reference spectral intensity in the at least one spectrum portion.

24. System according to claim 23, wherein the photo-detector is configured to implement at least three tunable spectral responses and the means are adapted to receive at least three configuration signals controlling the tuning of at least part of the shape of the at least three spectral responses respectively as a function of the difference between the shape of said source spectral intensity and the shape of said reference spectral intensity in at least three spectrum portions, and wherein the photo-detector is further adapted to generate at least three electrical signals as a function of the at least three configuration signals respectively,
wherein the control module is further adapted to change the at least three configuration signals so that the at least three generated electrical signals are substantially equal each other when the photo-detector is adapted to detect a radiation scattered by a white object.

25. System according to claim 24, wherein the at least three tunable spectral responses are implemented with at least three tunable spectral responsivities.

26. System according to claim 25, the photo-detector including:
a substantially depleted semiconductor region adapted to generate carriers at at least three depths as a function of the wavelength of the detected optical radiation;
wherein the means include at least three electrodes arranged in the semiconductor region;
wherein the at least three configuration signals are the voltage of the at least three electrodes and the at least three generated electrical signals are at least three current signals;
wherein the at least three electrodes are adapted to collect the carriers generated at the at least three depths and are adapted to generate therefrom the at least three current signals respectively,
wherein the control module is adapted to change the voltage of a first electrode out of the at least three electrodes in order to change the intensity of the current generated at the first electrode and to decrease the difference between the current generated at the first electrode and the current generated at a second electrode out of the at least three electrodes.

27. System according to claim 25, the photo-detector including a semiconductor region including at least three depleted regions at different depths adapted to generate carriers as a function of at least three wavelengths of the detected optical radiation,
wherein the at least three generated electrical signals are at least three current signals including the carriers generated at the least three depleted regions respectively.

28. System according to claim 19, wherein the at least two tunable spectral responses are implemented with at least two tunable spectral responsivities.

29. System according to claim 28, the photo-detector including:
a substantially depleted semiconductor region adapted to generate carriers at at least three depths as a function of the wavelength of the detected optical radiation;
wherein the means include at least three electrodes arranged in the semiconductor region;
wherein the at least three configuration signals are the voltage of the at least three electrodes and the at least three generated electrical signals are at least three current signals;
wherein the at least three electrodes are adapted to collect the carriers generated at the at least three depths and are adapted to generate therefrom the at least three current signals respectively,
wherein the control module is adapted to change the voltage of a first electrode out of the at least three electrodes in order to change the intensity of the current generated at the first electrode and to decrease the difference between the current generated at the first electrode and the current generated at a second electrode out of the at least three electrodes.

30. System according to claim 28, the photo-detector including a semiconductor region including at least three depleted regions at different depths adapted to generate carriers as a function of at least three wavelengths of the detected optical radiation,
wherein the at least three generated electrical signals are at least three current signals including the carriers generated at the least three depleted regions respectively.

31. System according to claim 21, wherein the at least two tunable spectral responses are three tunable spectral responses being function of the wavelengths substantially corresponding to red, green, blue visible radiation respectively and wherein three spectrum portions include the wavelengths substantially corresponding to red, green, blue visible radiation.

32. Digital camera, in particular a digital video camera, including a system for acquisition of an image, the system including, the system including:
a photo-detector of a radiation, the photo-detector being configured to implement at least two tunable spectral responses indicating the sensitivity of the photo-detector as a function of the wavelength, the photo-detector including means for receiving at least two configuration signals controlling the tuning of at least part of the shape of the at least two spectral responses respectively;
a control module configured to:
receive an identification signal indicating the spectral intensity of a source of light and detecting that the shape of the source spectral intensity in at least one spectrum portion is different from the shape of a reference spectral intensity in the at least one spectrum portion;
change a configuration signal out of the at least two configuration signals in order to change the shape of a spectral response out of the at least two spectral responses in the at least one spectrum portion as a function of the difference between the shape of said source spectral intensity and the shape of said reference spectral intensity in the at least one spectrum portion;
wherein the photo-detector implements for each pixel at least three spectral responses tunable according to at least three electrical configuration signals, wherein the control module is further adapted to change the at least three electrical configuration signals for each pixel as a function of the difference between the shape of the source spectral intensity and the shape of the reference spectral intensity in at least three spectrum portions respectively.

33. Method for detecting a radiation, the method comprising the steps of:
receiving information indicating the spectral intensity of a source of light;
providing a photo-detector implementing at least two spectral responses indicating the sensitivity of the photo-detector as a function of the wavelength, wherein at least part of the shape of the at least two spectral responses is tunable;
providing at least two configuration signals for controlling the tuning of the at least part of the shape of the at least two spectral responses;
detecting that the shape of the source spectral intensity in at least one spectrum portion is different from the shape of a reference spectral intensity in the at least one spectrum portion;
changing a configuration signal out of the at least two configuration signals in order to change the shape of a spectral response out of the at least two spectral responses in the at least one spectrum portion as a function of the difference between the shape of said source spectral intensity and the shape of said reference spectral intensity in the at least one spectrum portion.

34. Method according to claim 33, wherein:
the step of detecting includes the detection that the values of the source spectral intensity in a spectrum portion are smaller than the values of the reference spectral intensity in said spectrum portion;
the step of changing includes the change of said configuration signal in order to increase the values of said spectral response in said spectrum portion.

35. Method according to claim 34, wherein the step of changing includes changing another configuration signal out of the at least two configuration signals in order to change the shape of the other spectral response in the at least one spectrum portion as a function of the difference between the shape of said source spectral intensity and the shape of said reference spectral intensity in the at least one spectrum portion.

36. Method according to claim 34, wherein the step of changing includes changing at least three configuration signals in order to change the shape of at least three spectral responses respectively in at least three spectrum portions as a function of the difference between the shape of said source spectral intensity and the shape of said reference spectral intensity in the at least three spectrum portions, in order to perform a white balancing of the radiation scattered by a white object and detected by the photo-detector.

37. Computer readable medium having a program recorded thereon, said computer readable medium comprising computer program code means adapted to perform the steps of detecting and changing of the method according to claim 33, when said program is run on a computer.
